(19) United States
(12) Patent Application Publication
(10) Pub. No.: US 2025/0279735 A1
(43) Pub. Date: Sep. 4, 2025

(54) Methods for generating net energy gain of electrical energy

(71) Applicant: Christopher David Wilson, Ankeny, IA (US)

(72) Inventor: Christopher David Wilson, Ankeny, IA (US)

(21) Appl. No.: 19/067,973

(22) Filed: Mar. 2, 2025

Related U.S. Application Data
(60) Provisional application No. 63/560,769, filed on Mar. 3, 2024.

(51) Int. Cl. H02N 11/00

(52) U.S. Cl. CPC H02N 11/008

(57) ABSTRACT

Methods for generating net energy gain of electrical energy, one method compromises one or more sources of alternating current to simultaneously transfer alternating current(s) directly to one or more electrical busbars (and/or one or more zero sided to twenty sided shape electrical conductors applied in the same manner as electrical busbars) and one or more step up transformers (and/or one or more voltage multipliers); the current(s) from the alternating current and/or direct current output(s) of the step up transformer(s) and/or voltage multiplier(s) is converted to static electric charges, while maintaining it's increased voltage(s); the increased voltage(s) static electric charges will then make contact with the electrical busbar(s) (and/or one or more zero sided to twenty sided shape electrical conductors applied in the same manner as electrical busbars) that has the alternating current(s) flowing through; creating a net energy gain of alternating current(s).

### CROSS REFERENCE TO RELATED APPLICATIONS

This application claims the benefit of U.S. Provisional Patent Application No. 63/560,769 filed on Mar. 3, 2024.

### BACKGROUND

The law of conservation of energy states that energy can neither be created nor destroyed, only converted from one form of energy to another. The second law of thermodynamics states that in a closed system, the total entropy (disorder) always increases over time. The law of conservation of momentum states that the total momentum of a system remains constant if no external forces are acting on it. Coulomb's law states that opposite charges attract each other, while like charges repel each other. The strength of the force between two charges is directly proportional to the product of the charges and inversely proportional to the square of the distance between them. Static electricity can be defined as electric charges having no motion and flow, which can cause the electric charges to build up and remain within or on the surface of a material until they can be moved away by an electric current or electrical discharge. Whereas electric current (current electricity) can be defined as the motion and flow of electric charges. Electric current can either be alternating current (flow of electric charges that periodically reverses direction) or direct current (electric charges that flows in one direction). Ohms law is a formula used to calculate the relationship between current (I), voltage (V), and resistance (R) through an electrical conductor. Ohms law formula can be classified by these three formulas, V=I·R, I=V/R, and R=V/I. Watts law is a formula used to calculate the relationship between power (watts), amperage (amps), and voltage (volts), and states that the power is determined by the voltage and amperage. Watts law formula can be classified by these three formulas, P=V·I, V=P/I, and I=P/V. Voltage (electric potential difference) can be looked as a pushing force and pressure that pushes current, causing the electric charges to flow. “Net energy gain” is a term used to describe a systems energy output being greater than its energy input.

### SUMMARY

Methods for generating net energy gain of electrical energy, one method compromises one or more sources of alternating current to simultaneously transfer alternating current(s) directly to one or more electrical busbars (and/or one or more zero sided to twenty sided shape electrical conductors applied in the same manner as electrical busbars) and one or more step up transformers (and/or one or more voltage multipliers); the current(s) from the alternating current and/or direct current output(s) of the step up transformer(s) and/or voltage multiplier(s) is converted to static electric charges, while maintaining it's increased voltage(s); the increased voltage(s) static electric charges will then make contact with the electrical busbar(s) (and/or one or more zero sided to twenty sided shape electrical conductors applied in the same manner as electrical busbars) that has the alternating current(s) flowing through; creating a net energy gain of alternating current(s). It is a feature of the present invention to provide methods for generating net energy gain of electrical energy that involves converting alternating current(s) and/or direct current(s) into static electric charges (causing the electric charges to have no motion and flow), to transfer the static electric charges to an electric current(s) to generate a net energy gain of alternating or direct current(s). It is a feature of the present invention to provide methods for generating net energy gain of electrical energy that can be configured to provide limitless nonstop electrical energy and be configured to operate 24 hours a day and 7 days a week. It is a feature of the present invention to provide methods for generating net energy gain of electrical energy that can be configured to produce and generate net energy gain of electrical energy output(s) ranging in hectowatts, kilowatts, megawatts, gigawatts, terawatts and higher.

### DRAWINGS

FIG. 1A is a diagram of a method variation using a source(s) of direct current to produce a net energy gain of alternating current(s);

FIG. 1B is a diagram of a method variation using a source(s) of direct current to produce a net energy gain of alternating current(s);

FIG. 1C is a diagram of a method variation using a source(s) of direct current to produce a net energy gain of alternating current(s);

FIG. 1D is a diagram of a method variation using a source(s) of alternating current to produce a net energy gain of alternating current(s);

FIG. 1E is a diagram of a method variation using a source(s) of alternating current to produce a net energy gain of alternating current(s);

FIG. 1F is a diagram of a method variation using a source(s) of direct current to produce a net energy gain of alternating current(s);

FIG. 1G is a diagram of a method variation using a source(s) of direct current to produce a net energy gain of alternating current(s);

FIG. 1H is a diagram of a method variation using a source(s) of direct current to produce a net energy gain of alternating current(s);

FIG. 1I is a diagram of a method variation using a source(s) of direct current to produce a net energy gain of direct current(s);

FIG. 1J is a diagram of a method variation using a source(s) of direct current to produce a net energy gain of direct current(s);

FIG. 1K is a diagram of a method variation using a source(s) of direct current to produce a net energy gain of direct current(s);

FIG. 1L is a diagram of a method variation using a source(s) of alternating current to produce a net energy gain of alternating current(s);

FIG. 1M is a diagram of a method variation using a source(s) of alternating current to produce a net energy gain of alternating current(s);

FIG. 1N is a diagram of a method variation using a source(s) of direct current to produce a net energy gain of direct current(s);

FIG. 1O is a diagram of a method variation using a source(s) of direct current to produce a net energy gain of direct current(s);

FIG. 1P is a diagram of a method variation using a source(s) of direct current to produce a net energy gain of direct current(s);

FIG. 1Q is a diagram of a method variation using a source(s) of alternating current to produce a net energy gain of direct current(s);

FIG. 1R is a diagram of a method variation using a source(s) of alternating current to produce a net energy gain of direct current(s);

FIG. 1S is a diagram of a method variation using a source(s) of alternating current to produce a net energy gain of direct current(s);

FIG. 1T is a diagram of a method variation using a source(s) of alternating current to produce a net energy gain of direct current(s);

FIG. 2A is a diagram of a method variation using artificial light and photovoltaics to produce a net energy gain of alternating current(s);

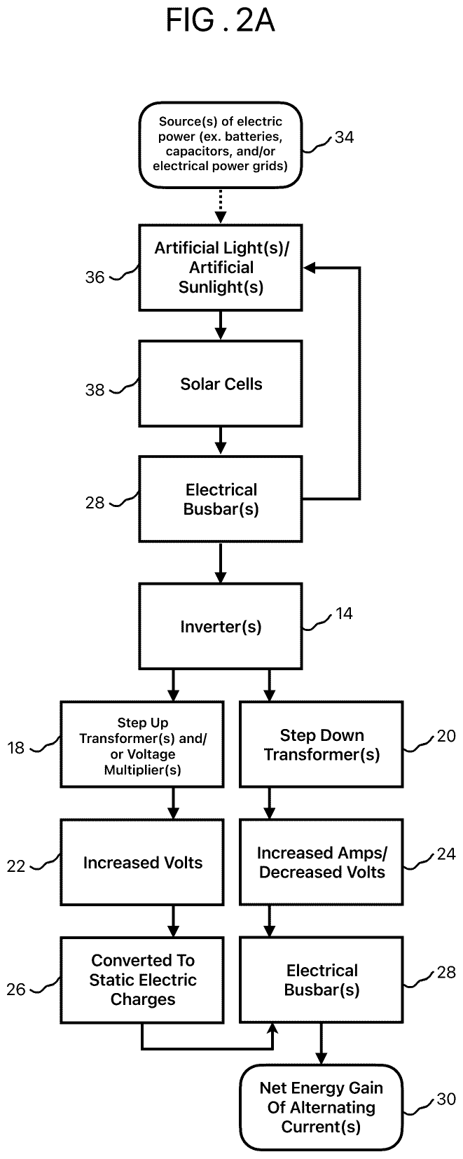

FIG. 2B is a diagram of a method variation using artificial light and photovoltaics to produce a net energy gain of alternating current(s);

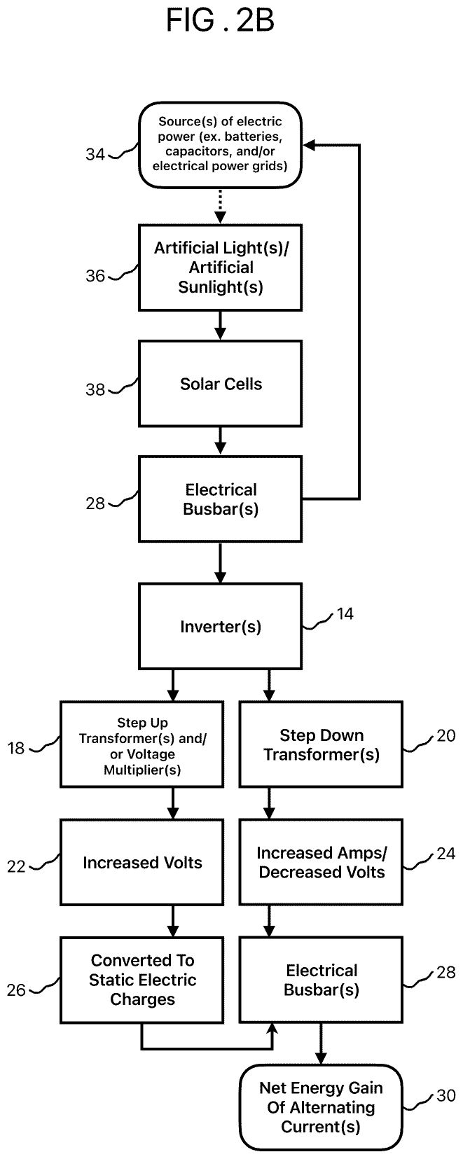

FIG. 3A is a diagram of the methods for generating net energy gain of electrical energy being applied towards a fusion reactor whose initial energy output was greater than its energy input;

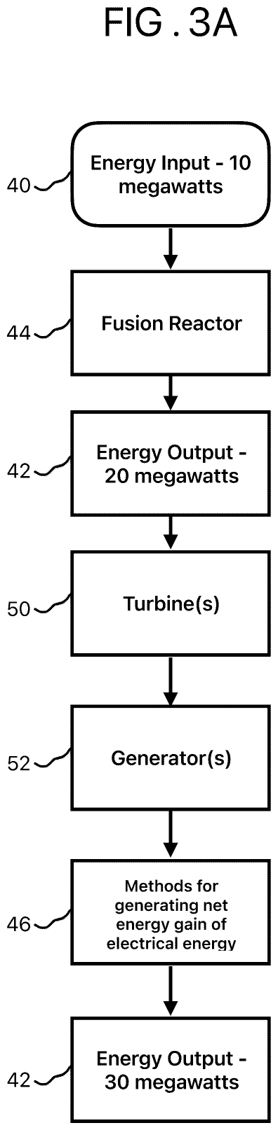

FIG. 3B is a diagram of the methods for generating net energy gain of electrical energy being applied towards a fusion reactor whose initial energy output was less than its energy input;

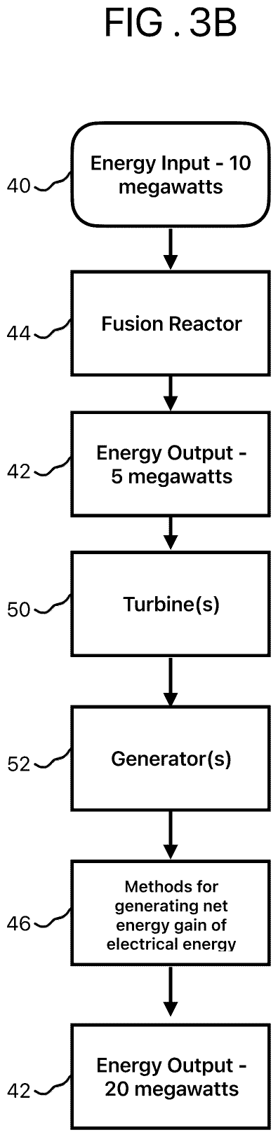

FIG. 3C is a diagram of the methods for generating net energy gain of electrical energy being applied towards the different methods of electricity generation;

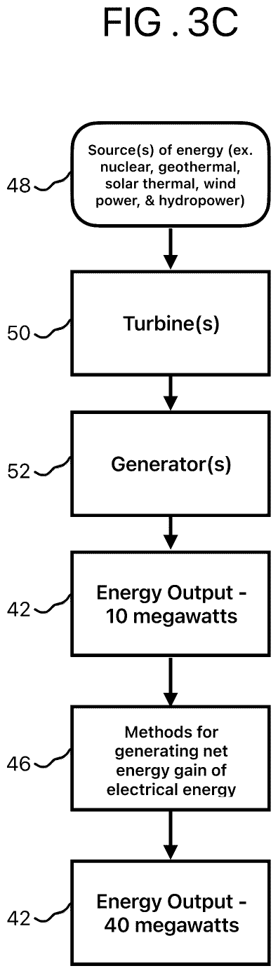

FIG. 3D is a diagram of the methods for generating net energy gain of electrical energy being applied towards the process of desalination;

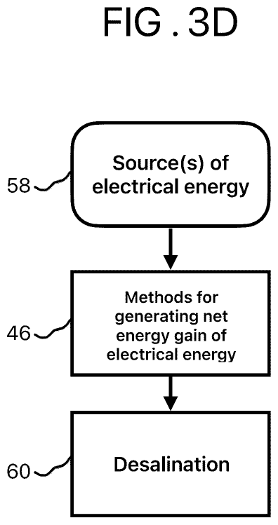

FIG. 3E is a diagram of the methods for generating net energy gain of electrical energy being applied to a electric motor(s) for an electric car;

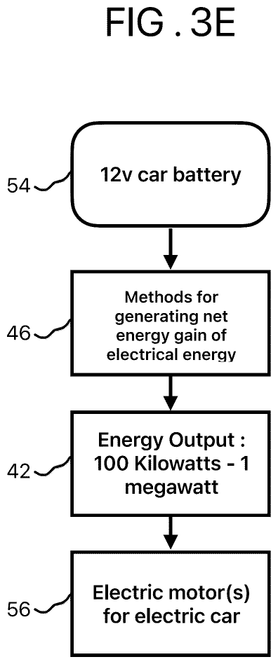

FIG. 3F is a diagram of the methods for generating net energy gain of electrical energy being applied towards an ion engine;

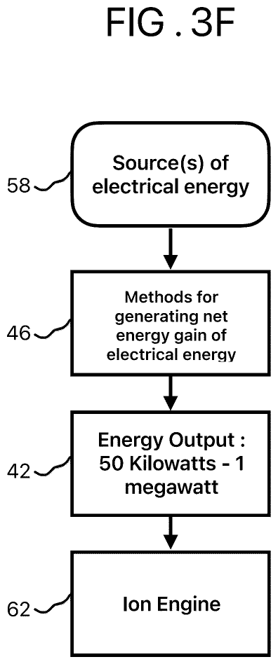

FIG. 3G is a diagram of the methods for generating net energy gain of electrical energy being applied to an electric motor(s) for an electric ship;

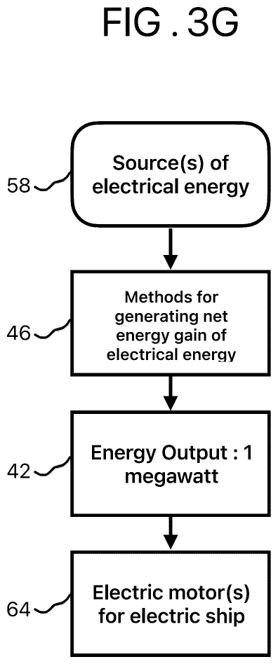

FIG. 3H is a diagram of the methods for generating net energy gain of electrical energy being applied to a electric motor(s) for an electric plane.

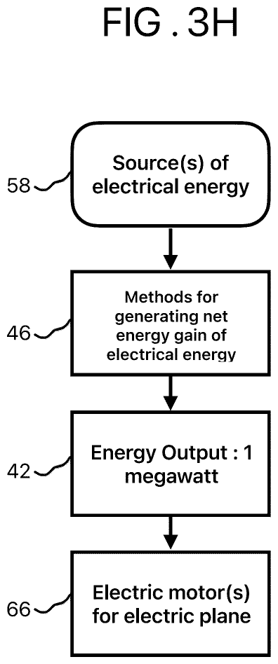

### DETAILED DESCRIPTION

The terminology used herein is for the purpose of describing particular embodiments only and is not intended to be limiting of the invention. As used herein, the terms “and”, “and/or” includes any and all combinations of one or more of the associated listed items. As used herein, the singular forms “a”, “an”, and “the” are intended to include the plural forms as well as the singular forms, unless the context clearly indicates otherwise. It will be further understood that the terms “comprises” and/or “comprising”, when used in this specification, specify the presence of stated features, steps, operations, elements, configurations, apparatuses and/or components, but do not preclude the presence or addition of one or more other features, steps, operations, elements, configurations, apparatuses, components, and/or groups thereof. Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein. In describing the invention, it will be understood that a number of methods, configurations, techniques and steps are disclosed. Each of these has individual benefit and each can also be used in conjunction with one or more, or in some cases all, of the other disclosed methods, configurations and techniques.

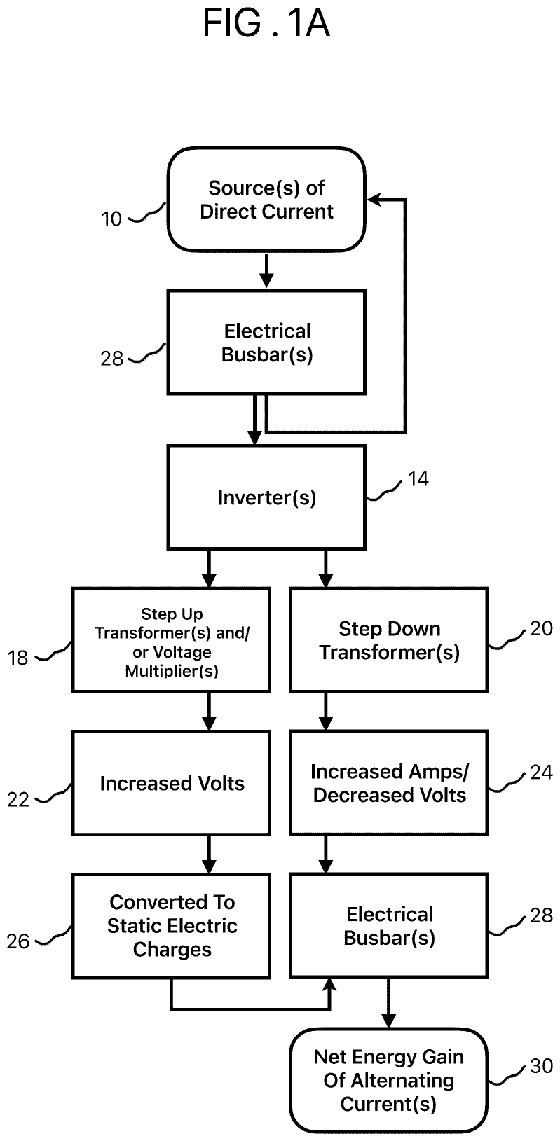

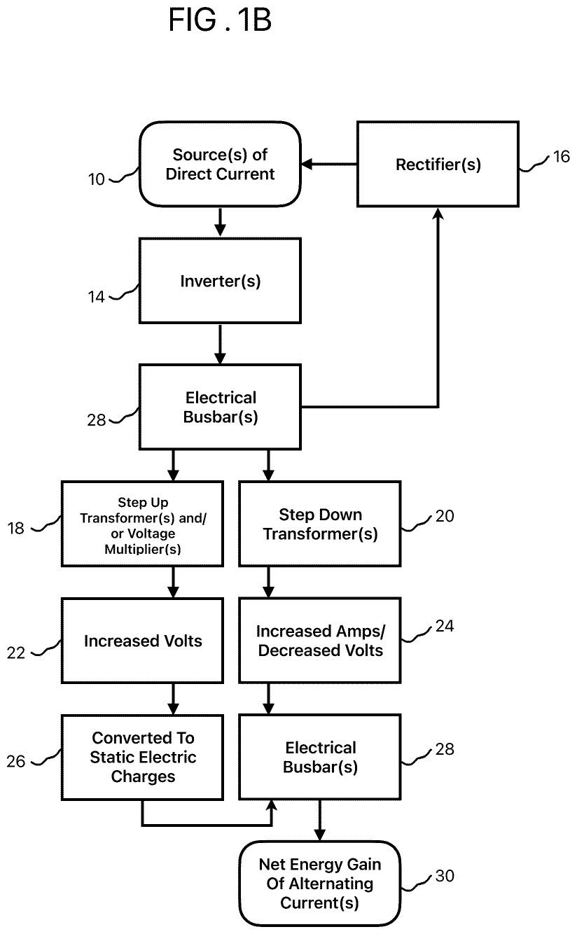

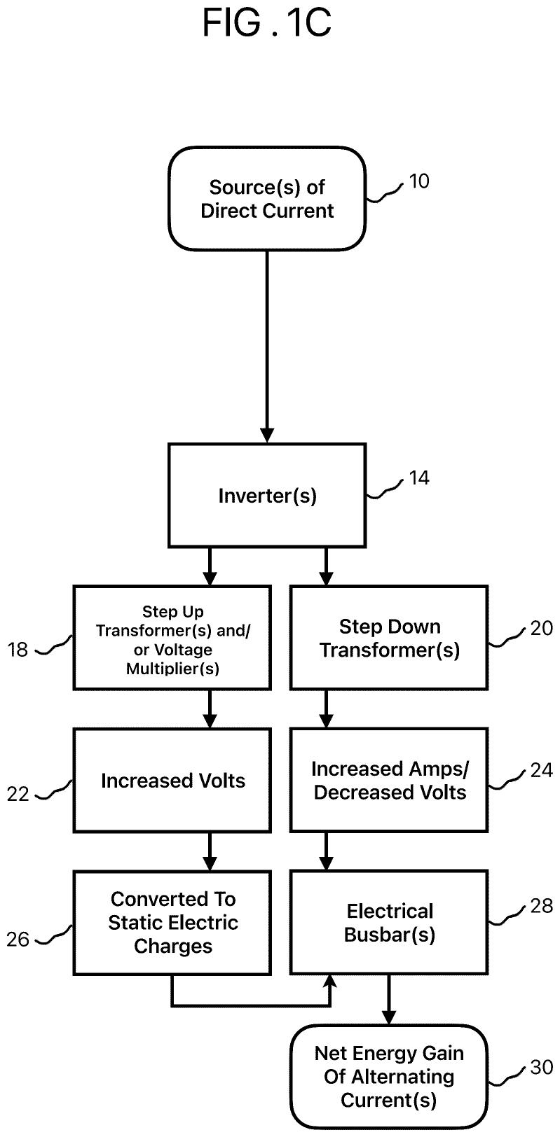

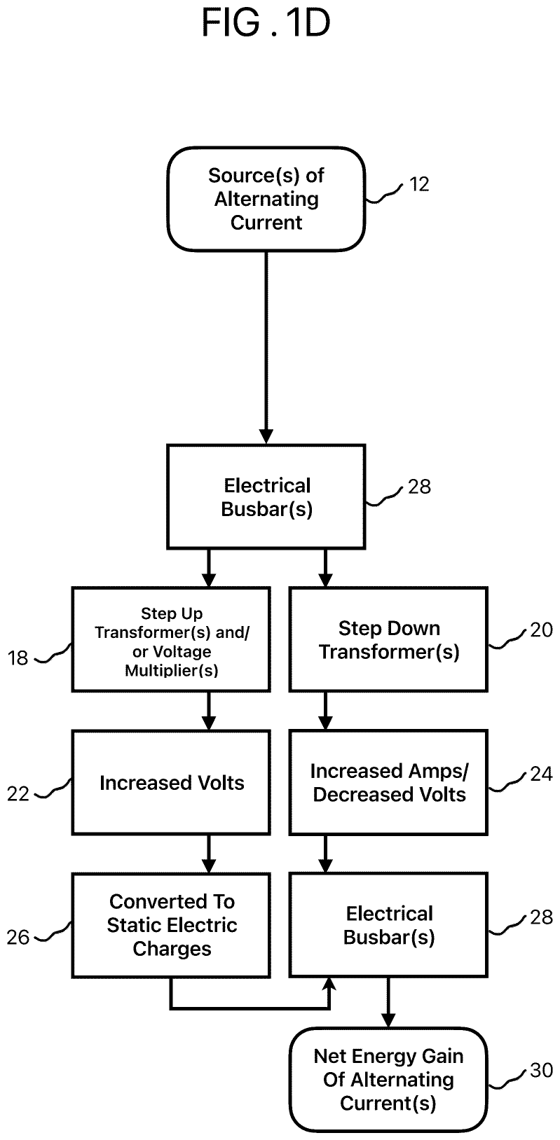

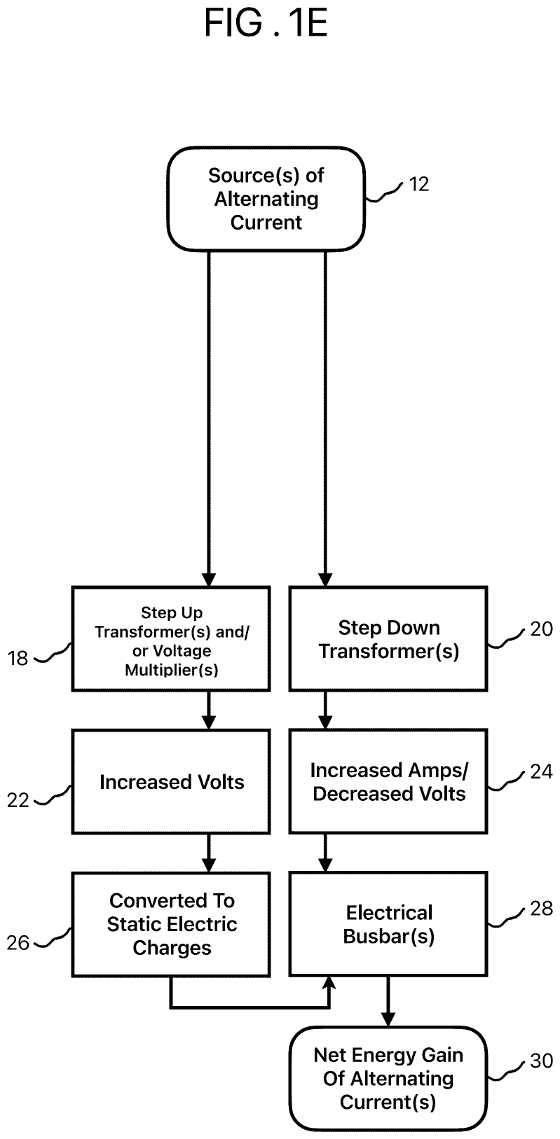

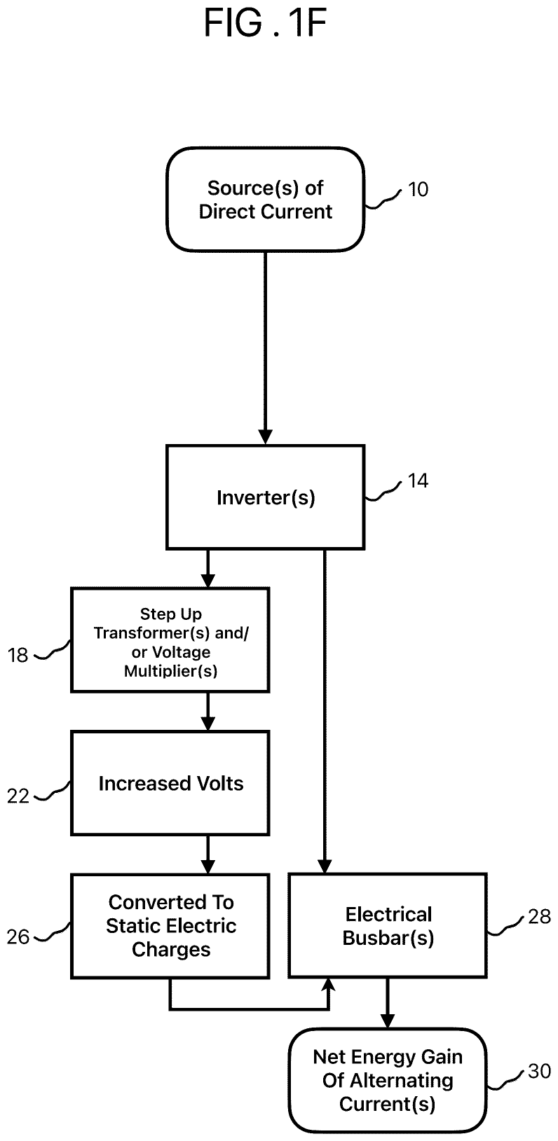

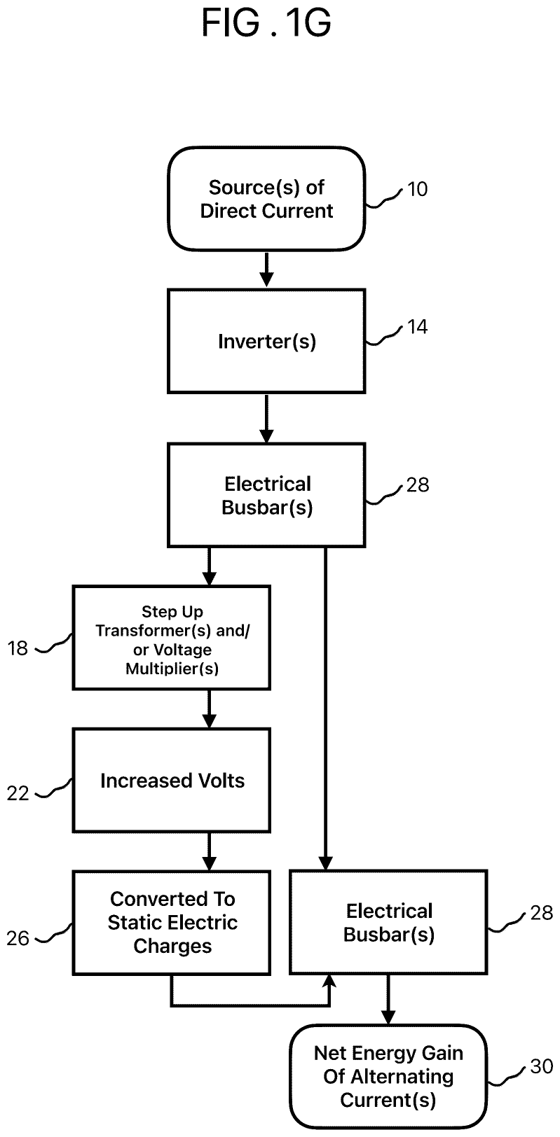

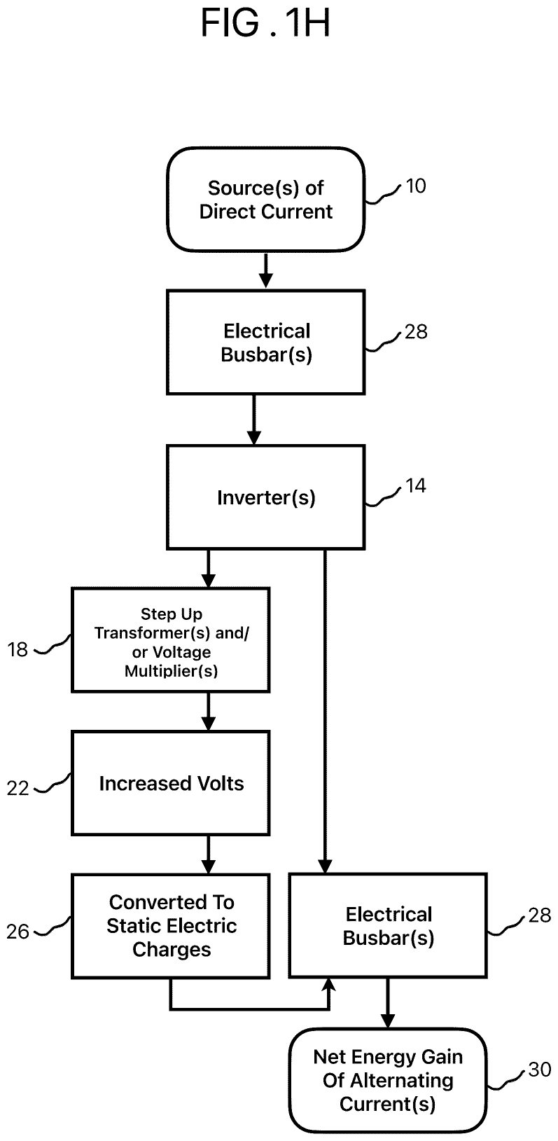

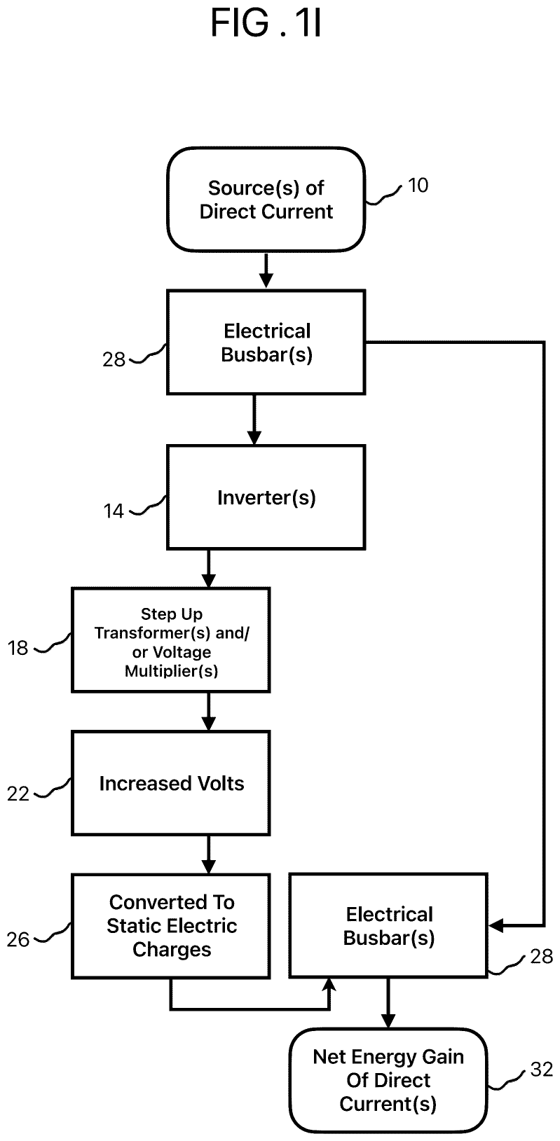

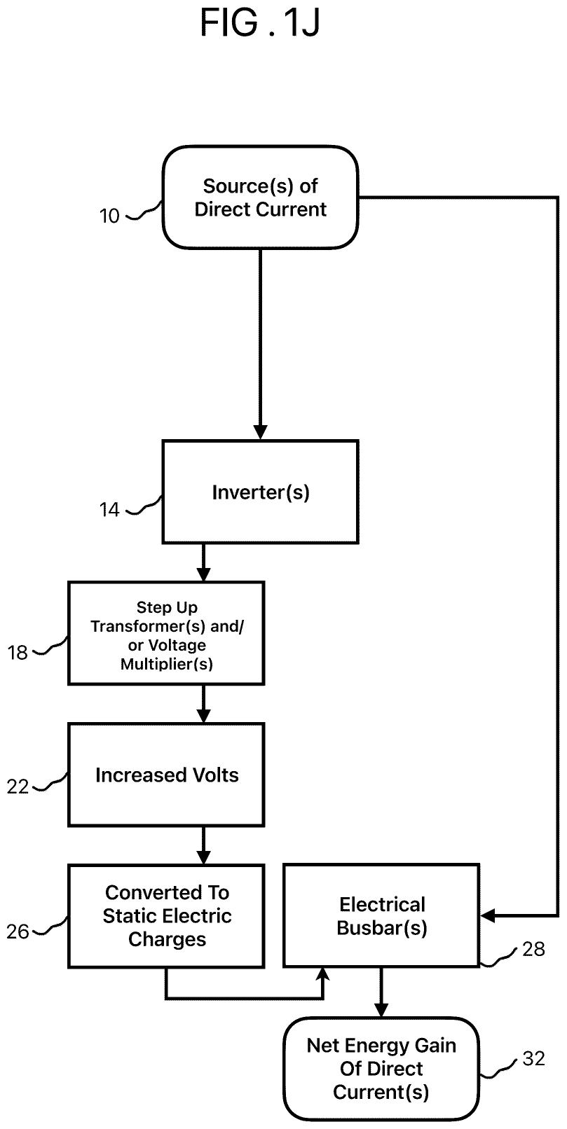

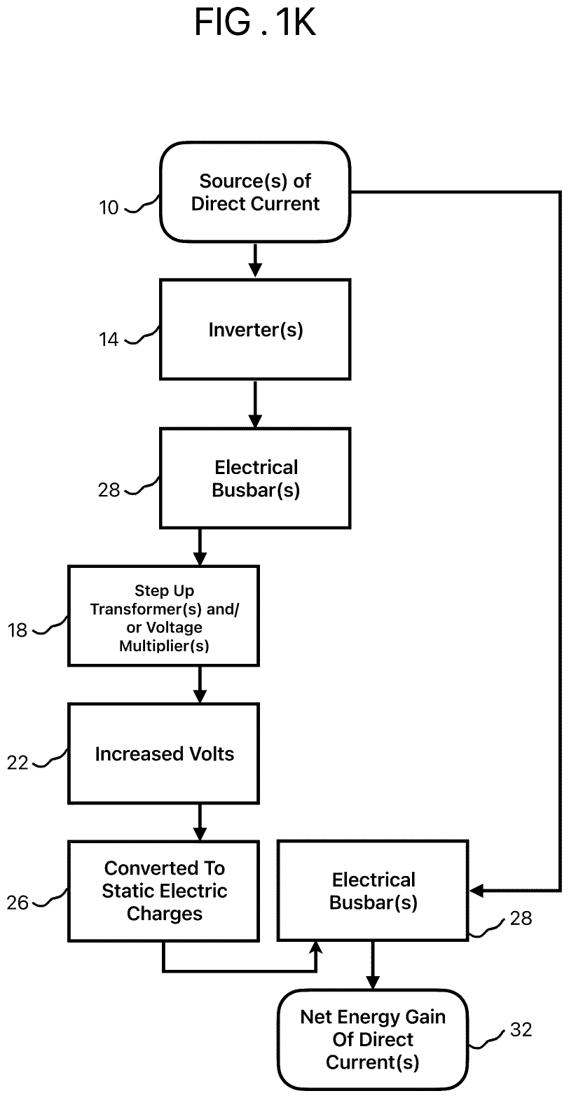

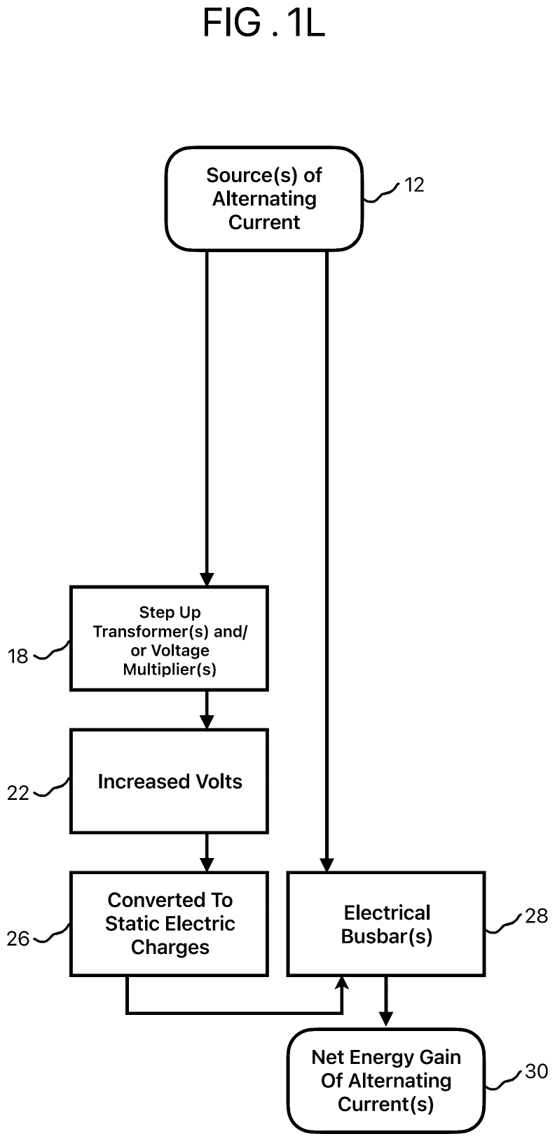

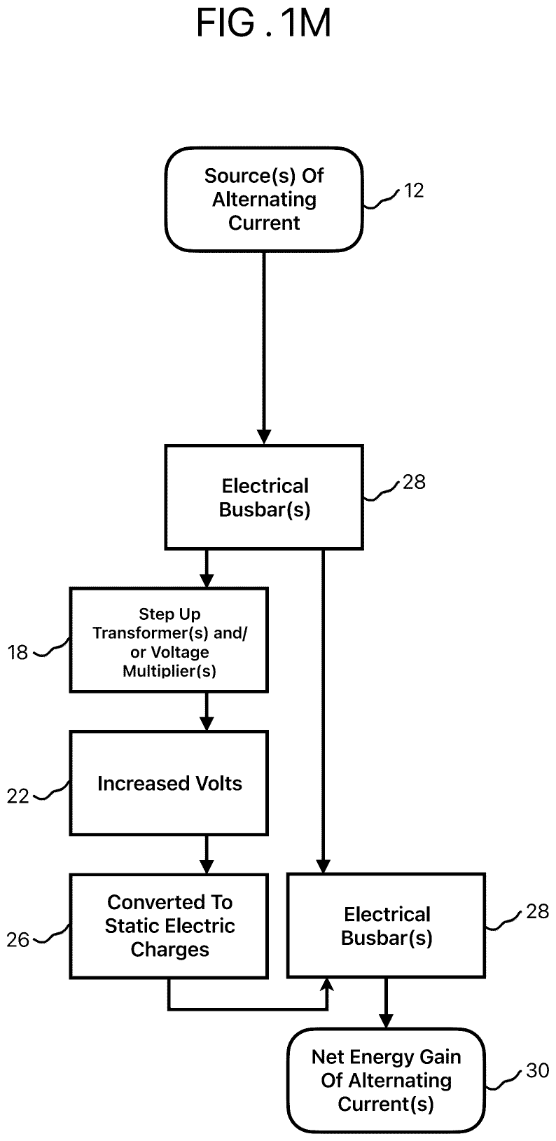

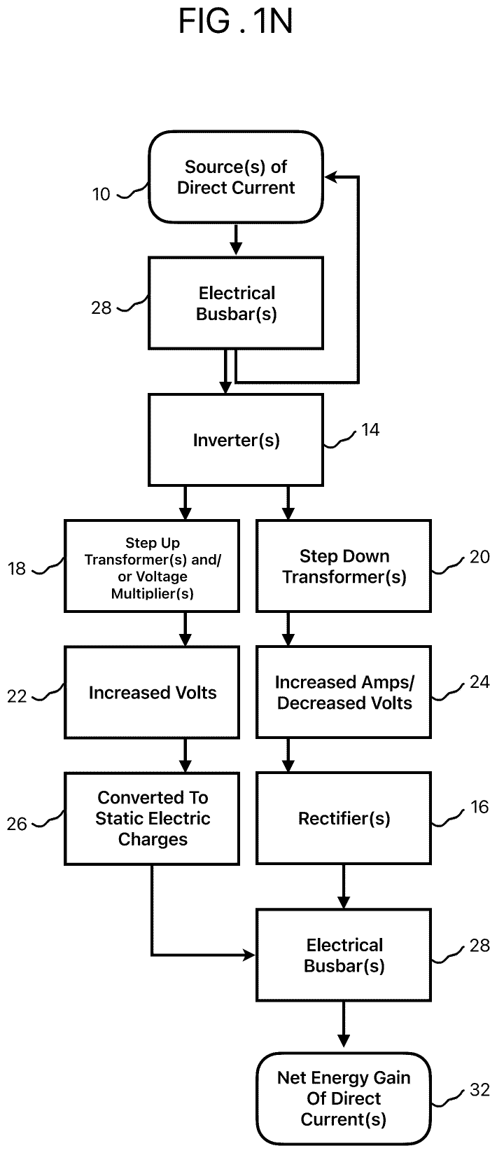

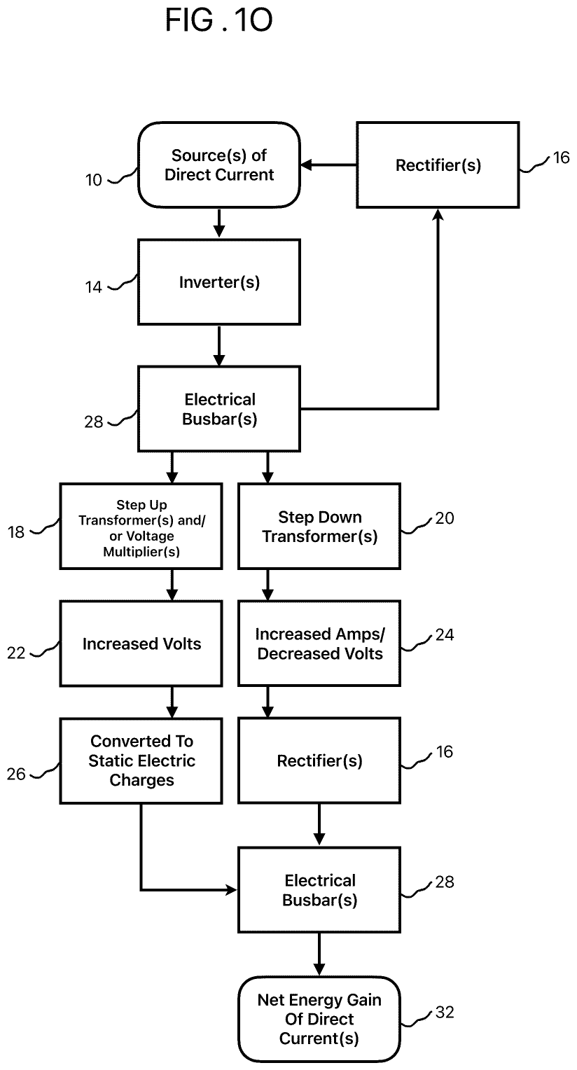

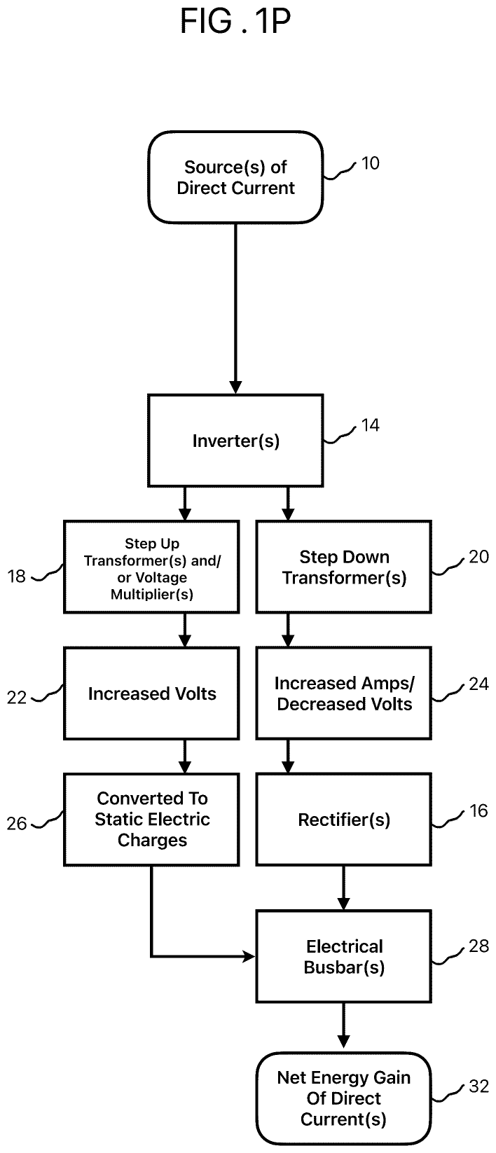

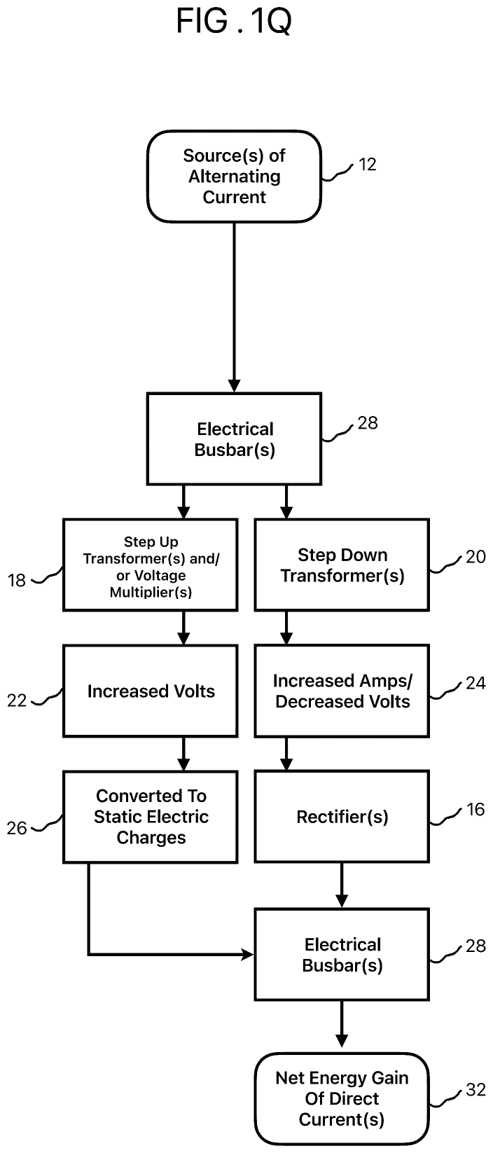

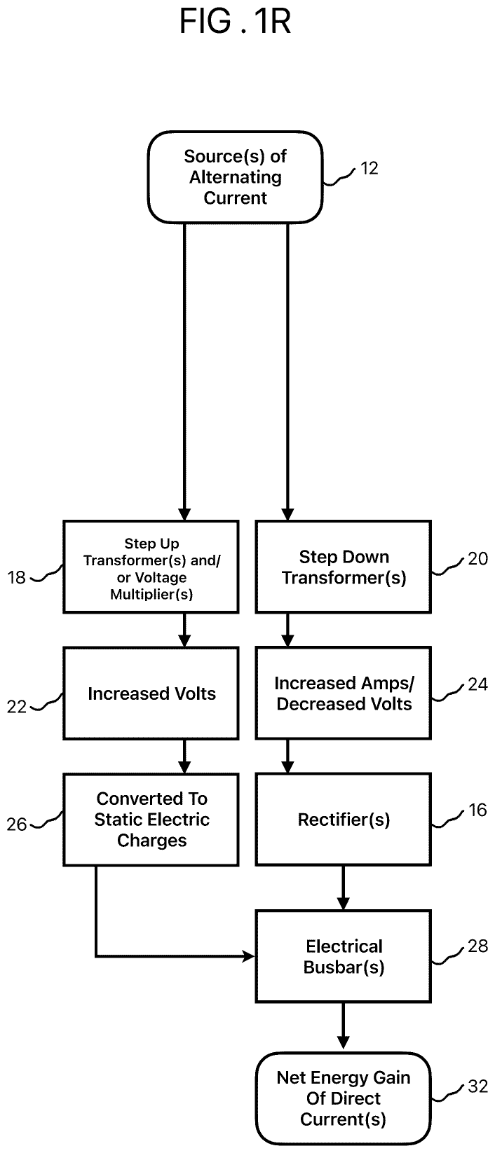

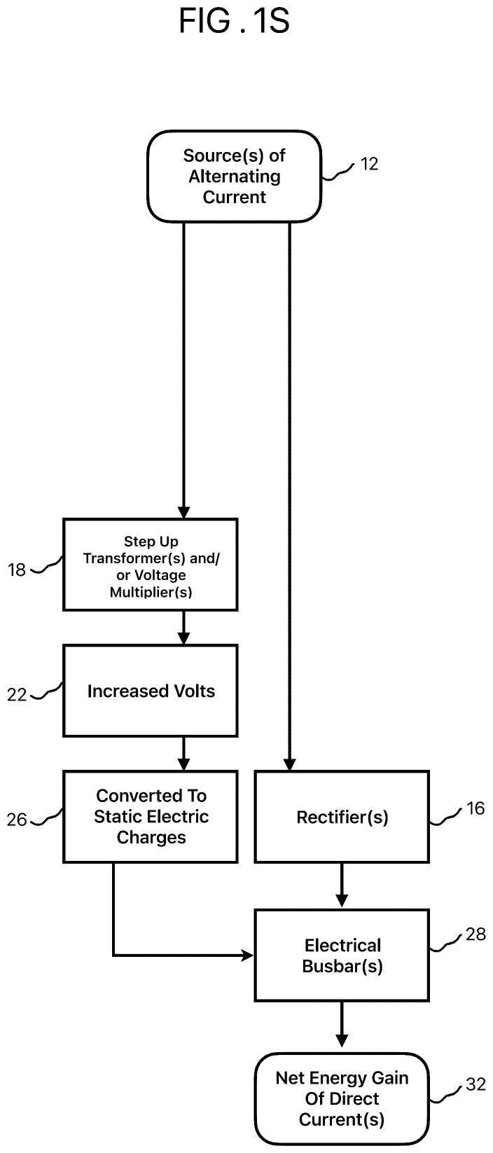

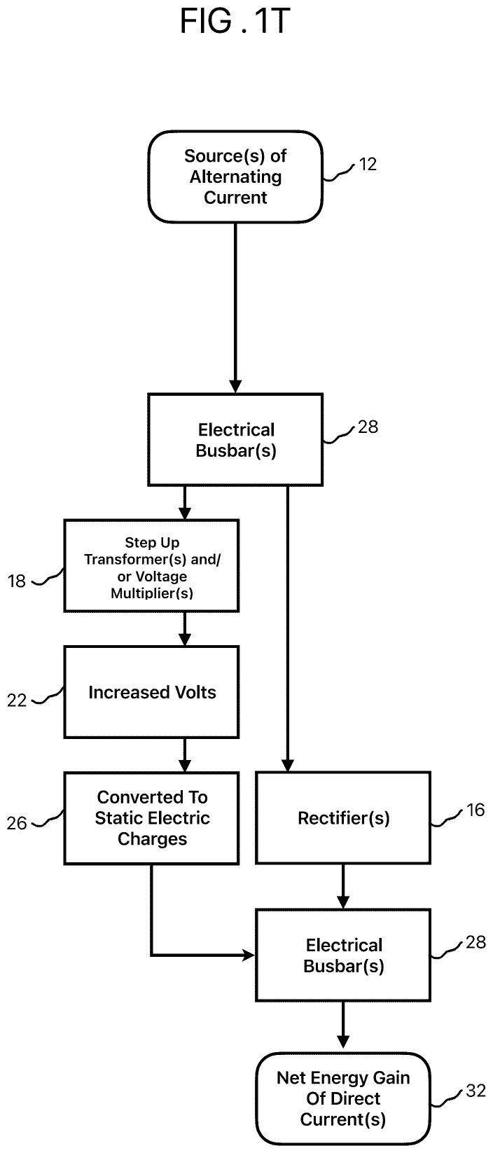

Accordingly, for the sake of clarity, this description will refrain from repeating every possible combination of the individual steps in an unnecessary fashion. Nevertheless, the specification and claims should be read with the understanding that such methods, configurations, embodiments and combinations are entirely within the scope of the invention and the claims. In the following description, for purposes of explanation, numerous specific details are set forth in order to provide a thorough understanding of the present invention. It will be evident, however, to one skilled in the art that the present invention may be practiced without these specific details. The present disclosure is to be considered as an exemplification of the invention, and is not intended to limit the invention to the specific embodiments illustrated by the figures or descriptions below. The present invention will now be described with the addition of the appended and reference numbers representing preferred embodiments and configurations. As illustrated in FIG. 1A, a method comprising one or more sources of direct current 10 to transfer direct current(s) via electrical conductor(s) to one or more electrical busbars (and/or one or more zero sided to twenty sided shape electrical conductors applied in the same manner as electrical busbars) 28; one or more electrical conductors is affix to the electrical busbar(s) (and/or one or more zero sided to twenty sided shape electrical conductors applied in the same manner as electrical busbars) 28 to redirect direct current(s) back into the source(s) of direct current 10; additional electrical conductor(s) is affix to the electrical busbar(s) (and/or one or more zero sided to twenty sided shape electrical conductors applied in the same manner as electrical busbars) 28 to transfer direct current(s) to one or more inverters 14 to convert the direct current(s) into alternating current(s); the alternating current(s) is transferred to one or more step up transformers (and/or one or more voltage multipliers) 18 and one or more step down transformers 20; the alternating current output(s) (increased amps/decreased volts) 24 from the step down transformer(s) 20, is transferred to one or more secondary electrical busbar(s) (and/or one or more secondary zero sided to twenty sided shape electrical conductors applied in the same manner as electrical busbars) 28; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) 28 that has the alternating current(s) (increased amps/decreased volts) 24 from the step down transformer(s) 20 flowing through; creating a net energy gain of alternating current(s) 30, by totaling (adding) the amount of voltage(s) of the static electric charges with the voltage(s) of the alternating current(s), while maintaining the increased ampere (amps) of the alternating current(s) provided by the step down transformer(s) 20. As illustrated in FIG. 1B, a second method comprising one or more sources of direct current 10 to transfer direct current(s) via electrical conductor(s) to one or more inverters 14 to convert it into alternating current(s); the alternating current(s) is transferred to one or more electrical busbars (and/or one or more zero sided to twenty sided shape electrical conductors applied in the same manner as electrical busbars) 28; one or more electrical conductors is affix to the electrical busbar(s) 28 to redirect alternating current(s) through one or more rectifiers 16 to convert back into direct current(s), so it can be redirected back into the source(s) of direct current 10; additional electrical conductor(s) are affix to the electrical busbar(s) (and/or one or more zero sided to twenty sided shape electrical conductors applied in the same manner as electrical busbars) 28 to transfer alternating current to one or more step up transformers (and/or one or more voltage multipliers) 18 and one or more step down transformers 20; the alternating current output(s) (increased amps/decreased volts) 24 from the step down transformer(s) 20, is transferred to one or more secondary electrical busbar(s) (and/or one or more secondary zero sided to twenty sided shape electrical conductors applied in the same manner as electrical busbars) 28; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) 28 that has the alternating current(s) (increased amps/decreased volts) 24 from the step down transformer(s) 20 flowing through; creating a net energy gain of alternating current(s) 30, by totaling (adding) the amount of voltage(s) of the static electric charges with the voltage(s) of the alternating current(s), while maintaining the increased ampere (amps) of the alternating current(s) provided by the step down transformer(s) 20. As illustrated in FIG. 1C, a third method comprising one or more sources of direct current 10 to transfer direct current(s) via electrical conductor(s) to one or more inverters 14 to convert it into alternating current(s); the alternating current(s) is transferred to one or more step up transformers (and/or one or more voltage multipliers) 18 and one or more step down transformers 20; the alternating current output(s) (increased amps/decreased volts) 24 from the step down transformer(s) 20, is transferred to one or more electrical busbar(s) (and/or one or more zero sided to twenty sided shape electrical conductors applied in the same manner as electrical busbars) 28; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the electrical busbar(s) (and/or one or more zero sided to twenty sided shape electrical conductors applied in the same manner as electrical busbars) 28 that has the alternating current(s) (increased amps/decreased volts) 24 from the step down transformer(s) 20 flowing through; creating a net energy gain of alternating current(s) 30, by totaling (adding) the amount of voltage(s) of the static electric charges with the voltage(s) of the alternating current(s), while maintaining the increased ampere (amps) of the alternating current(s) provided by the step down transformer(s) 20. As illustrated in FIG. 1D, a fourth method comprising one or more sources of alternating current 12 to transfer alternating current(s) via electrical conductor(s) to one or more electrical busbars (and/or one or more zero sided to twenty sided shape electrical conductors applied in the same manner as electrical busbars) 28; electrical conductor(s) are affix to the electrical busbar(s) (and/or one or more zero sided to twenty sided shape electrical conductors applied in the same manner as electrical busbars) 28 to transfer alternating current(s) to one or more step up transformers (and/or one or more voltage multipliers) 18 and one or more step down transformers 20; the alternating current output(s) (increased amps/decreased volts) 24 from the step down transformer(s) 20, is transferred to one or more secondary electrical busbar(s) (and/or one or more secondary zero sided to twenty sided shape electrical conductors applied in the same manner as electrical busbars) 28; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) 28 that has the alternating current(s) (increased amps/decreased volts) 24 from the step down transformer(s) 20 flowing through; creating a net energy gain of alternating current(s) 30, by totaling (adding) the amount of voltage(s) of the static electric charges with the voltage(s) of the alternating current(s), while maintaining the increased ampere (amps) of the alternating current(s) provided by the step down transformer(s) 20. As illustrated in FIG. 1E, a fifth method comprising one or more sources of alternating current 12 to transfer alternating current(s) via electrical conductor(s) to one or more step up transformers (and/or one or more voltage multipliers) 18 and one or more step down transformers 20; the alternating current output(s) (increased amps/decreased volts) 24 from the step down transformer(s) 20, is transferred to one or more electrical busbar(s) (and/or one or more zero sided to twenty sided shape electrical conductors applied in the same manner as electrical busbars) 28; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the electrical busbar(s) (and/or one or more zero sided to twenty sided shape electrical conductors applied in the same manner as electrical busbars) 28 that has the alternating current(s) (increased amps/decreased volts) 24 from the step down transformer(s) 20 flowing through; creating a net energy gain of alternating current(s) 30, by totaling (adding) the amount of voltage(s) of the static electric charges with the voltage(s) of the alternating current(s), while maintaining the increased ampere (amps) of the alternating current(s) provided by the step down transformer(s) 20. As illustrated in FIG. 1F, a sixth method comprising one or more sources of direct current 10 to transfer direct current(s) via electrical conductor(s) to one or more inverters 14 to convert it into alternating current(s); the alternating current(s) is then simultaneously transferred to one or more electrical busbars (and/or one or more zero sided to twenty sided shape electrical conductors applied in the same manner as electrical busbars) 28 and one or more step up transformers (and/or one or more voltage multipliers) 18; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the electrical busbar(s) (and/or one or more zero sided to twenty sided shape electrical conductors applied in the same manner as electrical busbars) 28 that has the alternating current(s) flowing through; creating a net energy gain of alternating current(s) 30 by totaling (adding) the amount of voltage(s) of the static electric charges with the voltage(s) of the alternating current(s). As illustrated in FIG. 1G, a seventh method comprising one or more sources of direct current 10 to transfer direct current(s) via electrical conductor(s) to one or more inverters 14 to convert it into alternating current(s), for the alternating current(s) to then be transferred to one or more electrical busbars (and/or one or more zero sided to twenty sided shape electrical conductors applied in the same manner as electrical busbars) 28; one or more electrical conductors is affix to the electrical busbar(s) (and/or one or more zero sided to twenty sided shape electrical conductors applied in the same manner as electrical busbars) 28 to simultaneously transfer alternating current(s) to one or more secondary electrical busbar(s) (and/or one or more secondary zero sided to twenty sided shape electrical conductors applied in the same manner as electrical busbars) 28 and one or more step up transformers (and/or one or more voltage multipliers) 18; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) 28 that has the alternating current(s) flowing through; creating a net energy gain of alternating current(s) 30 by totaling (adding) the amount of voltage(s) of the static electric charges with the voltage(s) of the alternating current(s). As illustrated in FIG. 1H, a eighth method comprising one or more sources of direct current 10 to transfer direct current(s) via electrical conductor(s) to one or more electrical busbars (and/or one or more zero sided to twenty sided shape electrical conductors applied in the same manner as electrical busbars) 28; one or more electrical conductors is affix to the electrical busbar(s) (and/or one or more zero sided to twenty sided shape electrical conductors applied in the same manner as electrical busbars) 28 to transfer direct current(s) to one or more inverters 14 to convert it into alternating current(s); the alternating current(s) is then simultaneously transferred to one or more secondary electrical busbar(s) (and/or one or more secondary zero sided to twenty sided shape electrical conductors applied in the same manner as electrical busbars) 28 and one or more step up transformers (and/or one or more voltage multipliers) 18; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) 28 that has the alternating current(s) flowing through; creating a net energy gain of alternating current(s) 30 by totaling (adding) the amount of voltage(s) of the static electric charges with the voltage(s) of the alternating current(s). As illustrated in FIG. 1I, a ninth method comprising one or more sources of direct current 10 to transfer direct current(s) via electrical conductor(s) to one or more electrical busbars (and/or one or more zero sided to twenty sided shape electrical conductors applied in the same manner as electrical busbars) 28; one or more electrical conductor(s) is affix to the electrical busbar(s) (and/or one or more zero sided to twenty sided shape electrical conductors applied in the same manner as electrical busbars) 28 to transfer direct current(s) to one or more secondary electrical busbar(s) (and/or one or more secondary zero sided to twenty sided shape electrical conductors applied in the same manner as electrical busbars) 28; additional electrical conductor(s) is affix to the first electrical busbar(s) (and/or the first one or more zero sided to twenty sided shape electrical conductors applied in the same manner as electrical busbars) 28 to transfer direct current(s) to one or more inverters 14 to convert it into alternating current(s), which is then transferred to one or more step up transformers (and/or one or more voltage multipliers) 18; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) 28 that has the direct current(s) flowing through; creating a net energy gain of direct current(s) 32 by totaling (adding) the amount of voltage(s) of the static electric charges with the voltage(s) of the direct current(s). As illustrated in FIG. 1J, a tenth method comprising one or more sources of direct current 10 to simultaneously transfer direct current(s) via electrical conductor(s) directly to one or more electrical busbars (and/or one or more zero sided to twenty sided shape electrical conductors applied in the same manner as electrical busbars) 28 and directly to one or more inverters 14 to convert it into alternating current(s); the alternating current(s) is then transferred to one or more step up transformers (and/or one or more voltage multipliers) 18; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the electrical busbar(s) (and/or one or more zero sided to twenty sided shape electrical conductors applied in the same manner as electrical busbars) 28 that has the direct current(s) flowing through; creating a net energy gain of direct current(s) 32 by totaling (adding) the amount of voltage(s) of the static electric charges with the voltage(s) of the direct current(s). As illustrated in FIG. 1K, a eleventh method comprising one or more sources of direct current 10 to simultaneously transfer direct current(s) via electrical conductor(s) directly to one or more electrical busbars (and/or one or more zero sided to twenty sided shape electrical conductors applied in the same manner as electrical busbars) 28 and directly to one or more inverters 14 to convert it into alternating current(s); the alternating current(s) is then transferred to one or more secondary electrical busbars (and/or one or more secondary zero sided to twenty sided shape electrical conductors applied in the same manner as electrical busbars) 28 separate from the first set of electrical busbar(s) (and/or first set of one or more zero sided to twenty sided shape electrical conductors applied in the same manner as electrical busbars) 28 that has the direct current(s) flowing through; one or more electrical conductors is affix to the secondary electrical busbar(s) (and/or one or more secondary zero sided to twenty sided shape electrical conductors applied in the same manner as electrical busbars) 28 to transfer alternating current(s) to one or more step up transformers (and/or one or more voltage multipliers) 18; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the first set of electrical busbar(s) (and/or first set of one or more zero sided to twenty sided shape electrical conductors applied in the same manner as electrical busbars) 28 that has the direct current(s) flowing through, creating a net energy gain of direct current(s) 32 by totaling (adding) the amount of voltage(s) of the static electric charges with the voltage(s) of the direct current(s). As illustrated in FIG. 1L, a twelfth method comprising one or more sources of alternating current 12 to simultaneously transfer alternating current(s) via electrical conductor(s) directly to one or more electrical busbars (and/or one or more zero sided to twenty sided shape electrical conductors applied in the same manner as electrical busbars) 28 and one or more step up transformers (and/or one or more voltage multipliers) 18; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the electrical busbar(s) (and/or one or more zero sided to twenty sided shape electrical conductors applied in the same manner as electrical busbars) 28 that has the alternating current(s) flowing through; creating a net energy gain of alternating current(s) 30 by totaling (adding) the amount of voltage(s) of the static electric charges with the voltage(s) of the alternating current(s). As illustrated in FIG. 1M, a thirteenth method comprising one or more sources of alternating current 12 to transfer alternating current(s) via electrical conductor(s) to one or more electrical busbars (and/or one or more zero sided to twenty sided shape electrical conductors applied in the same manner as electrical busbars) 28; one or more electrical conductors is affix to the electrical busbar(s) (and/or one or more zero sided to twenty sided shape electrical conductors applied in the same manner as electrical busbars) 28 to simultaneously transfer alternating current(s) to one or more secondary electrical busbar(s) (and/or one or more secondary zero sided to twenty sided shape electrical conductors applied in the same manner as electrical busbars) 28 and one or more step up transformers (and/or one or more voltage multipliers) 18; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) 28 that has the alternating current(s) flowing through; creating a net energy gain of alternating current(s) 30 by totaling (adding) the amount of voltage(s) of the static electric charges with the voltage(s) of the alternating current(s). As illustrated in FIG. 1N, a fourteenth method comprising one or more sources of direct current 10 to transfer direct current(s) via electrical conductor(s) to one or more electrical busbars (and/or one or more zero sided to twenty sided shape electrical conductors applied in the same manner as electrical busbars) 28; one or more electrical conductors is affix to the electrical busbar(s) (and/or one or more zero sided to twenty sided shape electrical conductors applied in the same manner as electrical busbars) 28 to redirect direct current(s) back into the source(s) of direct current 10; additional electrical conductor(s) is affix to the electrical busbar(s) (and/or one or more zero sided to twenty sided shape electrical conductors applied in the same manner as electrical busbars) 28 to transfer direct current(s) to one or more inverters 14 to convert the direct current(s) into alternating current(s); the alternating current(s) is transferred to one or more step up transformers (and/or one or more voltage multipliers) 18 and one or more step down transformers 20; the alternating current output(s) (increased amps/decreased volts) 24 from the step down transformer(s) 20, is transferred to one or more rectifiers 16 to be converted into direct current(s); the direct current(s) is then transferred to one or more secondary electrical busbar(s) (and/or one or more secondary zero sided to twenty sided shape electrical conductors applied in the same manner as electrical busbars) 28; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) 28 that has the direct current(s) (increased amps/decreased volts) 24 from the step down transformer(s) 20 flowing through; creating a net energy gain of direct current(s) 32, by totaling (adding) the amount of voltage(s) of the static electric charges with the voltage(s) of the direct current(s), while maintaining the increased ampere (amps) of the direct current(s) provided by the step down transformer(s) 20. As illustrated in FIG. 1O, a fifteenth method comprising one or more sources of direct current 10 to transfer direct current(s) via electrical conductor(s) to one or more inverters 14 to convert it into alternating current(s); the alternating current(s) is transferred to one or more electrical busbars (and/or one or more zero sided to twenty sided shape electrical conductors applied in the same manner as electrical busbars) 28; one or more electrical conductors is affix to the electrical busbar(s) 28 to redirect alternating current(s) through one or more rectifiers 16 to convert back into direct current(s), so it can be redirected back into the source(s) of direct current 10; additional electrical conductor(s) are affix to the electrical busbar(s) (and/or one or more zero sided to twenty sided shape electrical conductors applied in the same manner as electrical busbars) 28 to transfer alternating current to one or more step up transformers (and/or one or more voltage multipliers) 18 and one or more step down transformers 20; the alternating current output(s) (increased amps/decreased volts) 24 from the step down transformer(s) 20, is transferred to one or more rectifiers 16 to be converted into direct current(s); the direct current(s) is then transferred to one or more secondary electrical busbar(s) (and/or one or more secondary zero sided to twenty sided shape electrical conductors applied in the same manner as electrical busbars) 28; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) 28 that has the direct current(s) (increased amps/decreased volts) 24 from the step down transformer(s) 20 flowing through; creating a net energy gain of direct current(s) 32, by totaling (adding) the amount of voltage(s) of the static electric charges with the voltage(s) of the direct current(s), while maintaining the increased ampere (amps) of the direct current(s) provided by the step down transformer(s) 20. As illustrated in FIG. 1P, a sixteenth method comprising one or more sources of direct current 10 to transfer direct current(s) via electrical conductor(s) to one or more inverters 14 to convert it into alternating current(s); the alternating current(s) is transferred to one or more step up transformers (and/or one or more voltage multipliers) 18 and one or more step down transformers 20; the alternating current output(s) (increased amps/decreased volts) 24 from the step down transformer(s) 20, is transferred to one or more rectifiers 16 to be converted into direct current(s); the direct current(s) is then transferred to one or more electrical busbar(s) (and/or one or more zero sided to twenty sided shape electrical conductors applied in the same manner as electrical busbars) 28; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the electrical busbar(s) (and/or one or more zero sided to twenty sided shape electrical conductors applied in the same manner as electrical busbars) 28 that has the direct current(s) (increased amps/decreased volts) 24 from the step down transformer(s) 20 flowing through; creating a net energy gain of direct current(s) 32, by totaling (adding) the amount of voltage(s) of the static electric charges with the voltage(s) of the direct current(s), while maintaining the increased ampere (amps) of the direct current(s) provided by the step down transformer(s) 20. As illustrated in FIG. 1Q, a seventeenth method comprising one or more sources of alternating current 12 to transfer alternating current(s) via electrical conductor(s) to one or more electrical busbars (and/or one or more zero sided to twenty sided shape electrical conductors applied in the same manner as electrical busbars) 28; electrical conductor(s) are affix to the electrical busbar(s) (and/or one or more zero sided to twenty sided shape electrical conductors applied in the same manner as electrical busbars) 28 to transfer alternating current(s) to one or more step up transformers (and/or one or more voltage multipliers) 18 and one or more step down transformers 20; the alternating current output(s) (increased amps/decreased volts) 24 from the step down transformer(s) 20, is transferred to one or more rectifiers 16 to be converted into direct current(s); the direct current(s) is then transferred to one or more secondary electrical busbar(s) (and/or one or more secondary zero sided to twenty sided shape electrical conductors applied in the same manner as electrical busbars) 28; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) 28 that has the direct current(s) (increased amps/decreased volts) 24 from the step down transformer(s) 20 flowing through; creating a net energy gain of direct current(s) 32, by totaling (adding) the amount of voltage(s) of the static electric charges with the voltage(s) of the direct current(s), while maintaining the increased ampere (amps) of the direct current(s) provided by the step down transformer(s) 20. As illustrated in FIG. 1R, a eighteenth method comprising one or more sources of alternating current 12 to transfer alternating current(s) via electrical conductor(s) to one or more step up transformers (and/or one or more voltage multipliers) 18 and one or more step down transformers 20; the alternating current output(s) (increased amps/decreased volts) 24 from the step down transformer(s) 20, is transferred to one or more rectifiers 16 to be converted into direct current(s); the direct current(s) is then transferred to one or more electrical busbar(s) (and/or one or more zero sided to twenty sided shape electrical conductors applied in the same manner as electrical busbars) 28; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the electrical busbar(s) (and/or one or more zero sided to twenty sided shape electrical conductors applied in the same manner as electrical busbars) 28 that has the direct current(s) (increased amps/decreased volts) 24 from the step down transformer(s) 20 flowing through; creating a net energy gain of direct current(s) 32, by totaling (adding) the amount of voltage(s) of the static electric charges with the voltage(s) of the direct current(s), while maintaining the increased ampere (amps) of the direct current(s) provided by the step down transformer(s) 20. As illustrated in FIG. 1S, a nineteenth method comprising one or more sources of alternating current 12 to simultaneously transfer alternating current(s) via electrical conductor(s) directly to one or more rectifiers 16 to be converted into direct current(s) and one or more step up transformers (and/or one or more voltage multipliers) 18; the direct current(s) coming from the rectifier(s) 16 is transferred to one or more electrical busbars (and/or one or more zero sided to twenty sided shape electrical conductors applied in the same manner as electrical busbars) 28; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the electrical busbar(s) (and/or one or more zero sided to twenty sided shape electrical conductors applied in the same manner as electrical busbars) 28 that has the direct current(s) flowing through; creating a net energy gain of direct current(s) 32 by totaling (adding) the amount of voltage(s) of the static electric charges with the voltage(s) of the direct current(s). As illustrated in FIG. 1T, a twentieth method comprising one or more sources of alternating current 12 to transfer alternating current(s) via electrical conductor(s) to one or more electrical busbars (and/or one or more zero sided to twenty sided shape electrical conductors applied in the same manner as electrical busbars) 28; one or more electrical conductors is affix to the electrical busbar(s) (and/or one or more zero sided to twenty sided shape electrical conductors applied in the same manner as electrical busbars) 28 to simultaneously transfer alternating current(s) to one or more rectifiers 16 to be converted into direct current(s) and one or more step up transformers (and/or one or more voltage multipliers) 18; the direct current(s) coming from the rectifier(s) 16 is transferred to one or more secondary electrical busbar(s) (and/or one or more secondary zero sided to twenty sided shape electrical conductors applied in the same manner as electrical busbars) 28; the current(s) (amps) from the alternating current and/or direct current output(s) of the step up transformer(s) (increased volts/decreased amps) and/or voltage multiplier(s) 18 (increased volts) 22 is converted to static electric charges 26 (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) 28 that has the direct current(s) flowing through; creating a net energy gain of direct current(s) 32 by totaling (adding) the amount of voltage(s) of the static electric charges with the voltage(s) of the direct current(s). Although the present invention has been illustrated and described herein with reference to preferred embodiments, configurations and specific examples thereof, it will be readily apparent to those of ordinary skill in the art that other embodiments, configurations and examples may perform similar functions and/or achieve like results. All such equivalent embodiments, configurations and examples are within the spirit and scope of the present invention, are contemplated thereby, and are intended to be covered by the following claims.

1. Methods for generating net energy gain of electrical energy:
a method comprising one or more sources of direct current to transfer direct current(s) via electrical conductor(s) to one or more electrical busbars (and/or one or more zero sided to twenty sided shape electrical conductors applied in the same manner as electrical busbars); one or more electrical conductors is affix to the electrical busbar(s) (and/or one or more zero sided to twenty sided shape electrical conductors applied in the same manner as electrical busbars) to redirect direct current(s) back into the source(s) of direct current; additional electrical conductor(s) is affix to the electrical busbar(s) (and/or one or more zero sided to twenty sided shape electrical conductors applied in the same manner as electrical busbars) to transfer direct current(s) to one or more inverters to convert the direct current(s) into alternating current(s); the alternating current(s) is transferred to one or more step up transformers (and/or one or more voltage multipliers) and one or more step down transformers; the alternating current output(s) (increased amps/decreased volts) from the step down transformer(s), is transferred to one or more secondary electrical busbar(s) (and/or one or more secondary zero sided to twenty sided shape electrical conductors applied in the same manner as electrical busbars); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) that has the alternating current(s) (increased amps/decreased volts) from the step down transformer(s) flowing through; creating a net energy gain of alternating current(s), by totaling (adding) the amount of voltage(s) of the static electric charges with the voltage(s) of the alternating current(s), while maintaining the increased ampere (amps) of the alternating current(s) provided by the step down transformer(s); and
a method comprising one or more sources of direct current to transfer direct current(s) via electrical conductor(s) to one or more inverters to convert it into alternating current(s); the alternating current(s) is transferred to one or more electrical busbars (and/or one or more zero sided to twenty sided shape electrical conductors applied in the same manner as electrical busbars); one or more electrical conductors is affix to the electrical busbar(s) to redirect alternating current(s) through one or more rectifiers to convert back into direct current(s), so it can be redirected back into the source(s) of direct current; additional electrical conductor(s) are affix to the electrical busbar(s) (and/or one or more zero sided to twenty sided shape electrical conductors applied in the same manner as electrical busbars) to transfer alternating current to one or more step up transformers (and/or one or more voltage multipliers) and one or more step down transformers; the alternating current output(s) (increased amps/decreased volts) from the step down transformer(s), is transferred to one or more secondary electrical busbar(s) (and/or one or more secondary zero sided to twenty sided shape electrical conductors applied in the same manner as electrical busbars); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) that has the alternating current(s) (increased amps/decreased volts) from the step down transformer(s) flowing through; creating a net energy gain of alternating current(s), by totaling (adding) the amount of voltage(s) of the static electric charges with the voltage(s) of the alternating current(s), while maintaining the increased ampere (amps) of the alternating current(s) provided by the step down transformer(s); and
a method comprising one or more sources of direct current to transfer direct current(s) via electrical conductor(s) to one or more inverters to convert it into alternating current(s); the alternating current(s) is transferred to one or more step up transformers (and/or one or more voltage multipliers) and one or more step down transformers; the alternating current output(s) (increased amps/decreased volts) from the step down transformer(s), is transferred to one or more electrical busbar(s) (and/or one or more zero sided to twenty sided shape electrical conductors applied in the same manner as electrical busbars); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the electrical busbar(s) (and/or one or more zero sided to twenty sided shape electrical conductors applied in the same manner as electrical busbars) that has the alternating current(s) (increased amps/decreased volts) from the step down transformer(s) flowing through; creating a net energy gain of alternating current(s), by totaling (adding) the amount of voltage(s) of the static electric charges with the voltage(s) of the alternating current(s), while maintaining the increased ampere (amps) of the alternating current(s) provided by the step down transformer(s); and
a method comprising one or more sources of alternating current to transfer alternating current(s) via electrical conductor(s) to one or more electrical busbars (and/or one or more zero sided to twenty sided shape electrical conductors applied in the same manner as electrical busbars); electrical conductor(s) are affix to the electrical busbar(s) (and/or one or more zero sided to twenty sided shape electrical conductors applied in the same manner as electrical busbars) to transfer alternating current(s) to one or more step up transformers (and/or one or more voltage multipliers) and one or more step down transformers; the alternating current output(s) (increased amps/decreased volts) from the step down transformer(s), is transferred to one or more secondary electrical busbar(s) (and/or one or more secondary zero sided to twenty sided shape electrical conductors applied in the same manner as electrical busbars); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) that has the alternating current(s) (increased amps/decreased volts) from the step down transformer(s) flowing through; creating a net energy gain of alternating current(s), by totaling (adding) the amount of voltage(s) of the static electric charges with the voltage(s) of the alternating current(s), while maintaining the increased ampere (amps) of the alternating current(s) provided by the step down transformer(s); and
a method comprising one or more sources of alternating current to transfer alternating current(s) via electrical conductor(s) to one or more step up transformers (and/or one or more voltage multipliers) and one or more step down transformers; the alternating current output(s) (increased amps/decreased volts) from the step down transformer(s), is transferred to one or more electrical busbar(s) (and/or one or more zero sided to twenty sided shape electrical conductors applied in the same manner as electrical busbars); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the electrical busbar(s) (and/or one or more zero sided to twenty sided shape electrical conductors applied in the same manner as electrical busbars) that has the alternating current(s) (increased amps/decreased volts) from the step down transformer(s) flowing through; creating a net energy gain of alternating current(s), by totaling (adding) the amount of voltage(s) of the static electric charges with the voltage(s) of the alternating current(s), while maintaining the increased ampere (amps) of the alternating current(s) provided by the step down transformer(s); and
a method comprising one or more sources of direct current to transfer direct current(s) via electrical conductor(s) to one or more inverters to convert it into alternating current(s); the alternating current(s) is then simultaneously transferred to one or more electrical busbars (and/or one or more zero sided to twenty sided shape electrical conductors applied in the same manner as electrical busbars) and one or more step up transformers (and/or one or more voltage multipliers); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the electrical busbar(s) (and/or one or more zero sided to twenty sided shape electrical conductors applied in the same manner as electrical busbars) that has the alternating current(s) flowing through; creating a net energy gain of alternating current(s) by totaling (adding) the amount of voltage(s) of the static electric charges with the voltage(s) of the alternating current(s); and
a method comprising one or more sources of direct current to transfer direct current(s) via electrical conductor(s) to one or more inverters to convert it into alternating current(s), for the alternating current(s) to then be transferred to one or more electrical busbars (and/or one or more zero sided to twenty sided shape electrical conductors applied in the same manner as electrical busbars); one or more electrical conductors is affix to the electrical busbar(s) (and/or one or more zero sided to twenty sided shape electrical conductors applied in the same manner as electrical busbars) to simultaneously transfer alternating current(s) to one or more secondary electrical busbar(s) (and/or one or more secondary zero sided to twenty sided shape electrical conductors applied in the same manner as electrical busbars) and one or more step up transformers (and/or one or more voltage multipliers); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) that has the alternating current(s) flowing through; creating a net energy gain of alternating current(s) by totaling (adding) the amount of voltage(s) of the static electric charges with the voltage(s) of the alternating current(s); and
a method comprising one or more sources of direct current to transfer direct current(s) via electrical conductor(s) to one or more electrical busbars (and/or one or more zero sided to twenty sided shape electrical conductors applied in the same manner as electrical busbars); one or more electrical conductors is affix to the electrical busbar(s) (and/or one or more zero sided to twenty sided shape electrical conductors applied in the same manner as electrical busbars) to transfer direct current(s) to one or more inverters to convert it into alternating current(s); the alternating current(s) is then simultaneously transferred to one or more secondary electrical busbar(s) (and/or one or more secondary zero sided to twenty sided shape electrical conductors applied in the same manner as electrical busbars) and one or more step up transformers (and/or one or more voltage multipliers); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) that has the alternating current(s) flowing through; creating a net energy gain of alternating current(s) by totaling (adding) the amount of voltage(s) of the static electric charges with the voltage(s) of the alternating current(s); and
a method comprising one or more sources of direct current to transfer direct current(s) via electrical conductor(s) to one or more electrical busbars (and/or one or more zero sided to twenty sided shape electrical conductors applied in the same manner as electrical busbars); one or more electrical conductor(s) is affix to the electrical busbar(s) (and/or one or more zero sided to twenty sided shape electrical conductors applied in the same manner as electrical busbars) to transfer direct current(s) to one or more secondary electrical busbar(s) (and/or one or more secondary zero sided to twenty sided shape electrical conductors applied in the same manner as electrical busbars); additional electrical conductor(s) is affix to the first electrical busbar(s) (and/or the first one or more zero sided to twenty sided shape electrical conductors applied in the same manner as electrical busbars) to transfer direct current(s) to one or more inverters to convert it into alternating current(s), which is then transferred to one or more step up transformers (and/or one or more voltage multipliers); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) that has the direct current(s) flowing through; creating a net energy gain of direct current(s) by totaling (adding) the amount of voltage(s) of the static electric charges with the voltage(s) of the direct current(s); and
a method comprising one or more sources of direct current to simultaneously transfer direct current(s) via electrical conductor(s) directly to one or more electrical busbars (and/or one or more zero sided to twenty sided shape electrical conductors applied in the same manner as electrical busbars) and directly to one or more inverters to convert it into alternating current(s); the alternating current(s) is then transferred to one or more step up transformers (and/or one or more voltage multipliers); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the electrical busbar(s) (and/or one or more zero sided to twenty sided shape electrical conductors applied in the same manner as electrical busbars) that has the direct current(s) flowing through; creating a net energy gain of direct current(s) by totaling (adding) the amount of voltage(s) of the static electric charges with the voltage(s) of the direct current(s); and
a method comprising one or more sources of direct current to simultaneously transfer direct current(s) via electrical conductor(s) directly to one or more electrical busbars (and/or one or more zero sided to twenty sided shape electrical conductors applied in the same manner as electrical busbars) and directly to one or more inverters to convert it into alternating current(s); the alternating current(s) is then transferred to one or more secondary electrical busbars (and/or one or more secondary zero sided to twenty sided shape electrical conductors applied in the same manner as electrical busbars) separate from the first set of electrical busbar(s) (and/or first set of one or more zero sided to twenty sided shape electrical conductors applied in the same manner as electrical busbars) that has the direct current(s) flowing through; one or more electrical conductors is affix to the secondary electrical busbar(s) (and/or one or more secondary zero sided to twenty sided shape electrical conductors applied in the same manner as electrical busbars) to transfer alternating current(s) to one or more step up transformers (and/or one or more voltage multipliers); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the first set of electrical busbar(s) (and/or first set of one or more zero sided to twenty sided shape electrical conductors applied in the same manner as electrical busbars) that has the direct current(s) flowing through, creating a net energy gain of direct current(s) by totaling (adding) the amount of voltage(s) of the static electric charges with the voltage(s) of the direct current(s); and
a method comprising one or more sources of alternating current to simultaneously transfer alternating current(s) via electrical conductor(s) directly to one or more electrical busbars (and/or one or more zero sided to twenty sided shape electrical conductors applied in the same manner as electrical busbars) and one or more step up transformers (and/or one or more voltage multipliers); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the electrical busbar(s) (and/or one or more zero sided to twenty sided shape electrical conductors applied in the same manner as electrical busbars) that has the alternating current(s) flowing through; creating a net energy gain of alternating current(s) by totaling (adding) the amount of voltage(s) of the static electric charges with the voltage(s) of the alternating current(s); and
a method comprising one or more sources of alternating current to transfer alternating current(s) via electrical conductor(s) to one or more electrical busbars (and/or one or more zero sided to twenty sided shape electrical conductors applied in the same manner as electrical busbars); one or more electrical conductors is affix to the electrical busbar(s) (and/or one or more zero sided to twenty sided shape electrical conductors applied in the same manner as electrical busbars) to simultaneously transfer alternating current(s) to one or more secondary electrical busbar(s) (and/or one or more secondary zero sided to twenty sided shape electrical conductors applied in the same manner as electrical busbars) and one or more step up transformers (and/or one or more voltage multipliers); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) that has the alternating current(s) flowing through; creating a net energy gain of alternating current(s) by totaling (adding) the amount of voltage(s) of the static electric charges with the voltage(s) of the alternating current(s); and
a method comprising one or more sources of direct current to transfer direct current(s) via electrical conductor(s) to one or more electrical busbars (and/or one or more zero sided to twenty sided shape electrical conductors applied in the same manner as electrical busbars); one or more electrical conductors is affix to the electrical busbar(s) (and/or one or more zero sided to twenty sided shape electrical conductors applied in the same manner as electrical busbars) to redirect direct current(s) back into the source(s) of direct current; additional electrical conductor(s) is affix to the electrical busbar(s) (and/or one or more zero sided to twenty sided shape electrical conductors applied in the same manner as electrical busbars) to transfer direct current(s) to one or more inverters to convert the direct current(s) into alternating current(s); the alternating current(s) is transferred to one or more step up transformers (and/or one or more voltage multipliers) and one or more step down transformers; the alternating current output(s) (increased amps/decreased volts) from the step down transformer(s), is transferred to one or more rectifiers to be converted into direct current(s); the direct current(s) is then transferred to one or more secondary electrical busbar(s) (and/or one or more secondary zero sided to twenty sided shape electrical conductors applied in the same manner as electrical busbars); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) that has the direct current(s) (increased amps/decreased volts) from the step down transformer(s) flowing through; creating a net energy gain of direct current(s), by totaling (adding) the amount of voltage(s) of the static electric charges with the voltage(s) of the direct current(s), while maintaining the increased ampere (amps) of the direct current(s) provided by the step down transformer(s); and
a method comprising one or more sources of direct current to transfer direct current(s) via electrical conductor(s) to one or more inverters to convert it into alternating current(s); the alternating current(s) is transferred to one or more electrical busbars (and/or one or more zero sided to twenty sided shape electrical conductors applied in the same manner as electrical busbars); one or more electrical conductors is affix to the electrical busbar(s) to redirect alternating current(s) through one or more rectifiers to convert back into direct current(s), so it can be redirected back into the source(s) of direct current; additional electrical conductor(s) are affix to the electrical busbar(s) (and/or one or more zero sided to twenty sided shape electrical conductors applied in the same manner as electrical busbars) to transfer alternating current to one or more step up transformers (and/or one or more voltage multipliers) and one or more step down transformers; the alternating current output(s) (increased amps/decreased volts) from the step down transformer(s), is transferred to one or more rectifiers to be converted into direct current(s); the direct current(s) is then transferred to one or more secondary electrical busbar(s) (and/or one or more secondary zero sided to twenty sided shape electrical conductors applied in the same manner as electrical busbars); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) that has the direct current(s) (increased amps/decreased volts) from the step down transformer(s) flowing through; creating a net energy gain of direct current(s), by totaling (adding) the amount of voltage(s) of the static electric charges with the voltage(s) of the direct current(s), while maintaining the increased ampere (amps) of the direct current(s) provided by the step down transformer(s); and
a method comprising one or more sources of direct current to transfer direct current(s) via electrical conductor(s) to one or more inverters to convert it into alternating current(s); the alternating current(s) is transferred to one or more step up transformers (and/or one or more voltage multipliers) and one or more step down transformers; the alternating current output(s) (increased amps/decreased volts) from the step down transformer(s), is transferred to one or more rectifiers to be converted into direct current(s); the direct current(s) is then transferred to one or more electrical busbar(s) (and/or one or more zero sided to twenty sided shape electrical conductors applied in the same manner as electrical busbars); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the electrical busbar(s) (and/or one or more zero sided to twenty sided shape electrical conductors applied in the same manner as electrical busbars) that has the direct current(s) (increased amps/decreased volts) from the step down transformer(s) flowing through; creating a net energy gain of direct current(s), by totaling (adding) the amount of voltage(s) of the static electric charges with the voltage(s) of the direct current(s), while maintaining the increased ampere (amps) of the direct current(s) provided by the step down transformer(s); and
a method comprising one or more sources of alternating current to transfer alternating current(s) via electrical conductor(s) to one or more electrical busbars (and/or one or more zero sided to twenty sided shape electrical conductors applied in the same manner as electrical busbars); electrical conductor(s) are affix to the electrical busbar(s) (and/or one or more zero sided to twenty sided shape electrical conductors applied in the same manner as electrical busbars) to transfer alternating current(s) to one or more step up transformers (and/or one or more voltage multipliers) and one or more step down transformers; the alternating current output(s) (increased amps/decreased volts) from the step down transformer(s), is transferred to one or more rectifiers to be converted into direct current(s); the direct current(s) is then transferred to one or more secondary electrical busbar(s) (and/or one or more secondary zero sided to twenty sided shape electrical conductors applied in the same manner as electrical busbars); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) that has the direct current(s) (increased amps/decreased volts) from the step down transformer(s) flowing through; creating a net energy gain of direct current(s), by totaling (adding) the amount of voltage(s) of the static electric charges with the voltage(s) of the direct current(s), while maintaining the increased ampere (amps) of the direct current(s) provided by the step down transformer(s); and
a method comprising one or more sources of alternating current to transfer alternating current(s) via electrical conductor(s) to one or more step up transformers (and/or one or more voltage multipliers) and one or more step down transformers; the alternating current output(s) (increased amps/decreased volts) from the step down transformer(s), is transferred to one or more rectifiers to be converted into direct current(s); the direct current(s) is then transferred to one or more electrical busbar(s) (and/or one or more zero sided to twenty sided shape electrical conductors applied in the same manner as electrical busbars); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the electrical busbar(s) (and/or one or more zero sided to twenty sided shape electrical conductors applied in the same manner as electrical busbars) that has the direct current(s) (increased amps/decreased volts) from the step down transformer(s) flowing through; creating a net energy gain of direct current(s), by totaling (adding) the amount of voltage(s) of the static electric charges with the voltage(s) of the direct current(s), while maintaining the increased ampere (amps) of the direct current(s) provided by the step down transformer(s); and
a method comprising one or more sources of alternating current to simultaneously transfer alternating current(s) via electrical conductor(s) directly to one or more rectifiers to be converted into direct current(s) and one or more step up transformers (and/or one or more voltage multipliers); the direct current(s) coming from the rectifier(s) is transferred to one or more electrical busbars (and/or one or more zero sided to twenty sided shape electrical conductors applied in the same manner as electrical busbars); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the electrical busbar(s) (and/or one or more zero sided to twenty sided shape electrical conductors applied in the same manner as electrical busbars) that has the direct current(s) flowing through; creating a net energy gain of direct current(s) by totaling (adding) the amount of voltage(s) of the static electric charges with the voltage(s) of the direct current(s); and
a method comprising one or more sources of alternating current to transfer alternating current(s) via electrical conductor(s) to one or more electrical busbars (and/or one or more zero sided to twenty sided shape electrical conductors applied in the same manner as electrical busbars); one or more electrical conductors is affix to the electrical busbar(s) (and/or one or more zero sided to twenty sided shape electrical conductors applied in the same manner as electrical busbars) to simultaneously transfer alternating current(s) to one or more rectifiers to be converted into direct current(s) and one or more step up transformers (and/or one or more voltage multipliers); the direct current(s) coming from the rectifier(s) is transferred to one or more secondary electrical busbar(s) (and/or one or more secondary zero sided to twenty sided shape electrical conductors applied in the same manner as electrical busbars); the current(s) (amps) from the alternating current and/or direct current output(s) of the step up transformer(s) (increased volts/decreased amps) and/or voltage multiplier(s) (increased volts) is converted to static electric charges (causing the electric charges to have no motion and flow), while maintaining it's increased voltage(s); the increased voltage(s) static electric charges will then make contact with the secondary electrical busbar(s) (and/or one or more secondary zero sided to twenty sided shape electrical conductors applied in the same manner as electrical busbars) that has the direct current(s) flowing through; creating a net energy gain of direct current(s) by totaling (adding) the amount of voltage(s) of the static electric charges with the voltage(s) of the direct current(s).

2. The methods according to claim 1 wherein comprise direct current generators, alternating current generators, capacitors, fuel cells, electric batteries, and/or photovoltaic methods (using solar cells, artificial light, and/or natural light) as sources of direct current and alternating current:
the capacitors dielectric materials comprise one or more of the following chemical elements such as hydrogen, helium, lithium, beryllium, boron, carbon, nitrogen, oxygen, fluorine, neon, sodium, magnesium, aluminum, silicon, phosphorus, sulfur, chlorine, argon, potassium, calcium, scandium, titanium, vanadium, chromium, manganese, iron, cobalt, nickel, copper, zinc, gallium, germanium, arsenic, selenium, bromine, krypton, rubidium, strontium, yttrium, zirconium, niobium, molybdenum, ruthenium, rhodium, palladium, silver, cadmium, indium, tin, antimony, tellurium, iodine, xenon, cesium, barium, lanthanum, cerium, praseodymium, neodymium, samarium, europium, gadolinium, terbium, dysprosium, holmium, and bismuth; and
the fuel cells and electric batteries comprise solid, liquid and/or gel electrolytes; the solid electrolytes, liquid electrolytes and/or gel electrolytes comprise one or more of the following chemical elements such as hydrogen, helium, lithium, beryllium, boron, carbon, nitrogen, oxygen, fluorine, neon, sodium, magnesium, aluminum, silicon, phosphorus, sulfur, chlorine, argon, potassium, calcium, scandium, titanium, vanadium, chromium, manganese, iron, cobalt, nickel, copper, zinc, gallium, germanium, arsenic, selenium, bromine, krypton, rubidium, strontium, yttrium, zirconium, niobium, molybdenum, ruthenium, rhodium, palladium, silver, cadmium, indium, tin, antimony, tellurium, iodine, xenon, cesium, barium, lanthanum, cerium, praseodymium, neodymium, samarium, europium, gadolinium, terbium, dysprosium, holmium, erbium, thulium, ytterbium, lutetium, hafnium, tantalum, tungsten, rhenium, osmium, iridium, platinum, gold, mercury, thallium, lead, and bismuth; and
the solar cells comprise one or more of the following chemical elements such as hydrogen, helium, lithium, beryllium, boron, carbon, nitrogen, oxygen, fluorine, neon, sodium, magnesium, aluminum, silicon, phosphorus, sulfur, chlorine, argon, potassium, calcium, scandium, titanium, vanadium, chromium, manganese, iron, cobalt, nickel, copper, zinc, gallium, germanium, arsenic, selenium, bromine, krypton, rubidium, strontium, yttrium, zirconium, niobium, molybdenum, ruthenium, rhodium, palladium, silver, cadmium, indium, tin, antimony, tellurium, iodine, xenon, cesium, barium, lanthanum, cerium, praseodymium, neodymium, samarium, europium, gadolinium, terbium, dysprosium, holmium, and bismuth.

3. The methods according to claim 1 wherein comprise conductors/conductive materials comprise of one or more of the following chemical elements such as hydrogen, helium, lithium, beryllium, boron, carbon, nitrogen, oxygen, fluorine, neon, sodium, magnesium, aluminum, silicon, phosphorus, sulfur, chlorine, argon, potassium, calcium, scandium, titanium, vanadium, chromium, manganese, iron, cobalt, nickel, copper, zinc, gallium, germanium, arsenic, selenium, bromine, krypton, rubidium, strontium, yttrium, zirconium, niobium, molybdenum, ruthenium, rhodium, palladium, silver, cadmium, indium, tin, antimony, tellurium, iodine, xenon, cesium, barium, lanthanum, cerium, praseodymium, neodymium, samarium, europium, gadolinium, terbium, dysprosium, holmium, erbium, thulium, ytterbium, lutetium, hafnium, tantalum, tungsten, rhenium, osmium, iridium, platinum, gold, mercury, thallium, lead, and bismuth.

4. The methods according to claim 1 wherein comprise non-conductive materials for converting alternating current(s) and/or direct current(s) into static electric charges:
the non-conductive materials comprise one or more of the following chemical elements such as hydrogen, helium, lithium, beryllium, boron, carbon, nitrogen, oxygen, fluorine, neon, sodium, magnesium, aluminum, silicon, phosphorus, sulfur, chlorine, argon, potassium, calcium, scandium, titanium, vanadium, chromium, manganese, iron, cobalt, nickel, copper, zinc, gallium, germanium, arsenic, selenium, bromine, krypton, rubidium, strontium, yttrium, zirconium, niobium, molybdenum, ruthenium, rhodium, palladium, silver, cadmium, indium, tin, antimony, tellurium, iodine, xenon, cesium, barium, lanthanum, cerium, praseodymium, neodymium, samarium, europium, gadolinium, terbium, dysprosium, holmium, erbium, thulium, ytterbium, lutetium, hafnium, tantalum, tungsten, rhenium, osmium, iridium, platinum, gold, mercury, thallium, lead, and bismuth.

5. The methods according to claim 1 wherein the step up transformer(s) and step down transformer(s) comprise single phases, double phases, and/or triple phases; while comprising any number of turns in the primary windings and secondary windings to achieve desired voltages (volts) and current (amps) electrical outputs.

6. The methods according to claim 1 wherein the voltage multiplier(s) comprise any number of capacitors and diodes to achieve desired voltage (volts):
the voltage multiplier(s) capacitors dielectric materials comprise one or more of the following chemical elements such as hydrogen, helium, lithium, beryllium, boron, carbon, nitrogen, oxygen, fluorine, neon, sodium, magnesium, aluminum, silicon, phosphorus, sulfur, chlorine, argon, potassium, calcium, scandium, titanium, vanadium, chromium, manganese, iron, cobalt, nickel, copper, zinc, gallium, germanium, arsenic, selenium, bromine, krypton, rubidium, strontium, yttrium, zirconium, niobium, molybdenum, ruthenium, rhodium, palladium, silver, cadmium, indium, tin, antimony, tellurium, iodine, xenon, cesium, barium, lanthanum, cerium, praseodymium, neodymium, samarium, europium, gadolinium, terbium, dysprosium, holmium, erbium, thulium, ytterbium, lutetium, hafnium, tantalum, tungsten, rhenium, osmium, iridium, platinum, gold, mercury, thallium, lead, and bismuth.

7. The methods according to claim 1 wherein comprises configurations of all the methods not redirecting alternating current(s) and direct current(s) back into the source(s) of alternating current and direct current.

8. The methods according to claim 1 wherein comprises configurations of all the methods redirecting alternating current(s) and direct current(s) back into the source(s) of alternating current and direct current before and/or after generating net energy gain of electrical energy.
